(19) United States
(12) Patent Application Publication
(10) Pub. No.: US 2013/0304577 A1
(43) Pub. Date: Nov. 14, 2013

(54) ADVERTISING SYSTEMS AND METHODS

(71) Applicant: Daniel Ladvocat Cintra, Brooklyn, NY (US)

(72) Inventor: Daniel Ladvocat Cintra, Brooklyn, NY (US)

(73) Assignee: Google Inc.

(21) Appl. No.: 13/467,908

(22) Filed: May 9, 2012

(51) Int. Cl. G06Q 30/02

(52) U.S. Cl. 705/14.54

(57) ABSTRACT

A method of managing advertisements includes obtaining, by a server, a set of keywords for an advertisement campaign of an advertisement network; performing a search using at least one of the set of keywords as a search query on one or more search engines; receiving search results based on the search query from the one or more search engines, the search results comprising a plurality of pages; identifying a set of pages that participate in the advertisement network from the plurality of pages; and associating the advertisement campaign with each page of the identified set of pages.

### TECHNICAL FIELD

The disclosure relates generally to the field of online advertising systems and methods, and, in particular, relate to systems and methods for matching advertisements to user interests.

### BACKGROUND

The Internet provides access to a wide variety of content. The ability to search that content and provide intelligent search results to a user continues to be a challenge. Moreover, providing advertisements for services or items that the user would like to purchase can be beneficial to both the users and the advertisers.

The accessible content provides an opportunity to place advertisements. Advertisements can be placed within content, such as a web page, image, or video, or the content can trigger the display of one or more advertisements, such as presenting an advertisement in an advertisement slot and/or in a pop-up window.

Advertisers can decide which ads are displayed within particular content using various advertising management tools. These tools may also allow an advertiser to follow the performance of various ads or ad campaigns. The parameters used to determine when to display a particular ad can also be changed using advertising management tools.

Generally, advertisement networks provide ad inventory across web pages and provide methods to show ads that are relevant to end users (e.g., select ads based on context or placement). However, these networks contain highly heterogeneous sets of websites and, as a whole, these networks do may not perform as well for transaction-oriented advertisers (e.g., advertisers who want to sell their products online). For example, if an advertiser has a campaign directed to the keyword “SLR camera,” the advertiser's advertisement might be shown on a page reviewing SLR cameras, a page providing a guide for cleaning an SLR camera, or a forum of customer complaints about SLR cameras. Displaying advertisements on all these types of pages may not provide as good a return on investment (ROI) for the advertiser as can be obtained.

### SUMMARY OF THE DISCLOSURE

A method of managing advertisements includes (but is not limited to) any one or combination of: (i) obtaining, by a server, a set of keywords for an advertisement campaign of an advertisement network; (ii) performing a search using at least one of the set of keywords as a search query on one or more search engines; (iii) receiving search results based on the search query from the one or more search engines, the search results comprising a plurality of pages; (iv) identifying a set of pages that participate in the advertisement network from the plurality of pages; and (v) associating the advertisement campaign with each page of the identified set of pages.

In various implementations, the method further includes providing one or more advertisements associated with the advertisement campaign to a page of the identified set of pages

In various implementations, the method further includes: receiving, from a user device, a user search query input into a search engine, the user search query corresponding to at least one of the set of keywords; providing search results based on the user search query, the search results comprising a plurality of pages; and providing a first advertisement from the advertisement campaign for display with the search results.

In some implementations, the method further includes: receiving a selection of a page from the search results; and providing a second advertisement associated with the advertisement campaign for display on the selected page.

In further implementations, the first advertisement and the second advertisement are associated with the same advertiser.

In further implementations, the first advertisement and the second advertisement are the same advertisement.

In various implementations, the method further includes determining relevance of each page of the plurality of pages to the first search query. The identifying the set of pages includes identifying a set of pages of the plurality of pages that participate in the advertisement network and have a relevance exceeding a predetermined threshold.

In some implementations, the relevance of each page of the plurality of pages is based on a position of the page in the search results.

In various implementations, the search query is selected based on a keyword in the set of keywords that meets a specified criterion.

In various implementations, the identifying the set of pages includes: comparing the plurality of pages to a catalog of pages participating in the advertisement network; and identifying the set of pages that correspond to pages of the catalog.

A method of managing advertisements includes (but is not limited to) any one or combination of: (i) receiving, by a server, search query input into a search engine; (ii) providing search results based on the search query, the search results comprising a plurality of pages; (iii) identifying a set of pages of the plurality of pages that participate in an advertisement network; (iv) providing a first advertisement associated with the advertisement campaign for display with the search results; (v) receiving a selection from the search results of a page from the set of pages; and (vi) providing a second advertisement associated with the advertisement campaign on the selected page.

In various implementations, the first advertisement and the second advertisement are associated with the same advertiser.

In various implementations, the first advertisement and the second advertisement are the same advertisement.

A computer program product for managing advertisements includes a computer-readable storage medium comprising code for (but not limited to any one or combination of): obtaining, by a server, a set of keywords for an advertisement campaign of an advertisement network; performing a search using at least one of the set of keywords as a search query on one or more search engines; receiving search results based on the search query from the one or more search engines, the search results comprising a plurality of pages; identifying a set of pages that participate in the advertisement network from the plurality of pages; and associating the advertisement campaign with each page of the identified set of pages.

In various implementations, the computer-readable storage medium further comprising code for: receiving, from a user device, a user search query input into a search engine, the user search query corresponding to at least one of the set of keywords; providing search results based on the user search query, the search results comprising a plurality of pages; and providing a first advertisement from the advertisement campaign for display with the search results.

In some implementations, the computer-readable storage medium further comprising code for: receiving a selection of a page from the search results; and providing a second advertisement associated with the advertisement campaign for display on the selected page.

In further implementations, the first advertisement and the second advertisement are associated with the same advertiser.

In further implementations, the first advertisement and the second advertisement are the same advertisement.

A system for managing advertisements includes an advertisement management server configured to (but not limited to any one or combination of): obtain a set of keywords for an advertisement campaign of an advertisement network, the server configured; perform a search using at least one of the set of keywords as a search query on one or more search engines; receive search results based on the search query from the one or more search engines, the search results comprising a plurality of pages; identify a set of pages that participate in the advertisement network from the plurality of pages; and associate the advertisement campaign with each page of the identified set of pages.

### BRIEF DESCRIPTION OF THE DRAWINGS

FIG. 1 is a block diagram of an example environment in which an advertisement management system manages advertising services according to various implementations of the disclosure.

FIG. 2 is a flowchart of an advertisement management process according to various implementations of the disclosure.

FIGS. 3A and 3B illustrate advertisement layouts according to various implementations of the disclosure.

FIG. 4 is a flowchart of an advertisement management process according to various implementations of the disclosure.

### DETAILED DESCRIPTION

Many users of the Internet employ search engines to search for particular information. When a user is provided with the search results, relevant advertisements can be provided together with the search results in a convenient manner, to maximize results for the advertisers and enhance the user experience.

Various implementations relate to an Internet advertisement providing system, method, and computer program product, which enables advertisements to be included with online search engine results. This may be performed to increase advertisement click revenue for the advertiser and to provide revenue for the provider of the online search engine. In addition, this may be performed to improve an end user's experience by providing additional relevant content to the user.

According to various implementations, if a search engine user does not select an advertisement when displayed with search results, the advertiser may receive a second opportunity for the search engine user to select the advertisement when the search engine user visits one of the identified websites provided in the search results. As such, various implementations can identify high-performing segments of advertisement networks so advertisers can obtain a higher return on investment and so end users can be provided with the most relevant content.

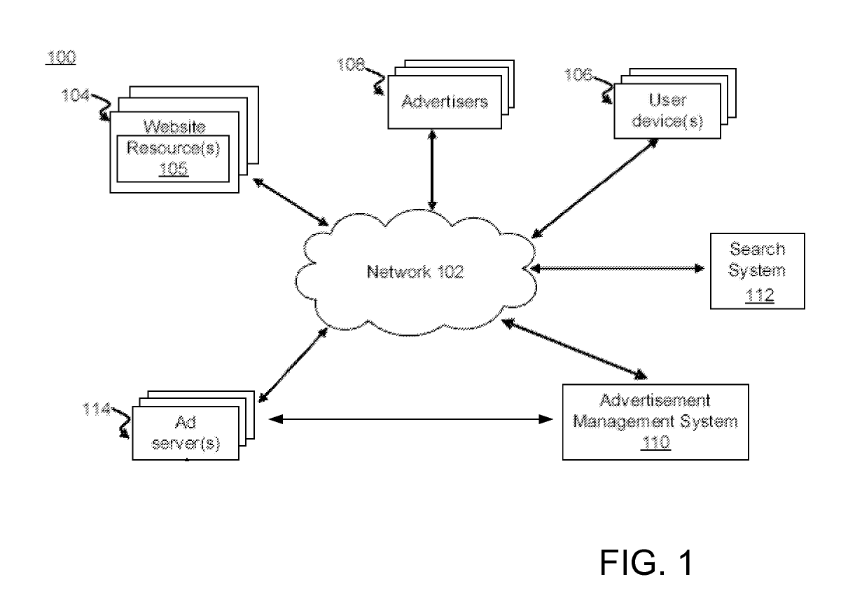

FIG. 1 is a block diagram of an environment in which an advertisement management system manages advertising services. The environment 100 includes a network 102, such as a local area network (LAN), a wide area network (WAN), the Internet, or a combination thereof. The network 102 connects websites 104, user devices 106, advertisers 108, and an advertisement management system 110. The environment 100 may include many thousands of websites 104, user devices 106, and advertisers 108.

The website 104 may be one or more resources 105 associated with a domain name and hosted by one or more servers. For instance, a website may be a collection of web pages formatted in hypertext markup language (HTML) that can contain text, images, multimedia content, and programming elements, such as scripts.

The resource 105 may be any data that can be provided over the network 102. The resource 105 may be identified by a resource address that is associated with the resource 105, such as a uniform resource locator (URL). The resource 105 may include web pages, word processing documents, portable document format (PDF) documents, images, video, programming elements, interactive content, feed sources, and/or any other type of content. The resource 105 can include content, such as words, phrases, images, and sounds, which may include embedded information (such as meta-information in hyperlinks) and/or embedded instructions (such as JavaScript™ scripts).

The user device 106 may be an electronic device that is controllable by a user and is capable of requesting and receiving resources (e.g., 105) over the network 102. User devices 106 may include, but are not limited to, personal computers, mobile communication devices, and other devices that can send and receive data over the network 102. The user device 106 typically includes a user application, such as a web browser, to facilitate the sending and receiving of data over the network 102.

The user device 106 can request the resources 105 from the website 104. In turn, data representing the resource 105 can be provided to the user device 106 for presentation by the user device 106. The data representing the resource 105 can include data specifying a portion of the resource 105 or a portion of a user display (e.g., a presentation location of a pop-up window or in a slot of a web page) in which advertisements or other sponsored content can be presented. These specified portions of the resource 105 or user display are referred to as advertisement slots.

To facilitate searching of the vast number of resources 105 accessible over the network 102, the environment 100 can include a search system 112 that identifies the resources 105 by crawling and indexing the resources provided on the websites 104. Data about the resources can be indexed based on the resource with which the data is associated. The indexed and, optionally, cached copies of the resources are stored in a search index (not shown).

The user device 106 can submit search queries to the search system 112 over the network 102. In response, the search system 112 accesses the search index to identify resources that are relevant to the search query. In some implementations, a search query includes one or more keywords. The search system 112 identifies the relevant resources 105 in the form of search results and returns the search results to the user device 106 in search results pages. A search result may be data generated by the search system 112 that identifies the resources 105 that are responsive to a particular search query, and includes a link to the resource 105. For instance, a search result can include a web page title, a snippet of text or a portion of an image extracted from the web page, a rendering of the resource, and the URL of the web page. Search results pages can also include one or more advertisement slots in which advertisements can be presented.

A search result page can be sent with a request from the search system 112 for the web browser of the user device 106 to set an HTTP (HyperText Transfer Protocol) cookie. A cookie can represent, for example, a particular user device 106 and a particular web browser. For example, the search system 112 includes a server that replies to the query by sending the search results page in an HTTP response. This HTTP response includes instructions (e.g., a set cookie instruction) that cause the browser to store a cookie for the site hosted by the server or for the domain of the server. If the browser supports cookies and cookies are enabled, every subsequent page request to the same server or a server within the domain of the server will include the cookie. The cookie can store a variety of data, including a unique or semi-unique identifier. The unique or semi-unique identifiers are anonymized and are not connected with user names. Because HTTP is a stateless protocol, the use of cookies allows an external service, such as the search system 112 or other system, to follow particular actions and status of a user over multiple sessions. A user may, at any time, opt out of allowing user actions to be followed, for example, by disabling cookies in the browser's settings. According to various implementations, the search system 112 does not follow user identifying information. In some implementations, a user may be required to opt in to enable user actions to be followed.

When a resource 105 or search results are requested by the user device 106, the advertisement management system 110 receives a request for advertisements to be provided with the resource 105 or search results. The request for advertisements can include characteristics of the advertisement slots that are defined for the requested resource or search results page and can be provided to the advertisement management system 110. For example, a reference (e.g., URL) to the resource 105 for which the advertisement slot is defined, a size of the advertisement slot, a position of the advertisement slot within the resources, and/or media types that are available for presentation in the advertisement slot can be provided to the advertisement management system 110. Similarly, keywords (i.e., one or more words that are associated with content) associated with a requested resource (“resource keywords”) or a search query for which search results are requested can also be provided to the advertisement management system 110 to facilitate identification of advertisements that are relevant to the resource 105 or search query.

Using data included in the request for advertisements, the advertisement management system 110 can select advertisements that are eligible to be provided in response to the request (“eligible advertisements” or “candidate advertisements”). For example, eligible advertisements can include advertisements having characteristics matching the characteristics of advertisement slots and that are identified as relevant to specified resource keywords or search queries. In some implementations, advertisements having keywords that match the resource keywords or the search query are selected as eligible advertisements by the advertisement management system 110.

The advertisement management system 110 selects an eligible advertisement for each advertisement slot of a resource 105 or of a search results page. The resource 105 or search results page may be received by the user device 106 for presentation to the user. In some implementations, the selected advertisement may be delivered to the user device via one or more advertisement servers 114.

The advertisers 108 can submit, to the advertisement management system 110, campaign parameters (e.g., matching keywords and corresponding bids) that are used to control distribution of advertisements. The advertisers 108 can access the advertisement management system 110 to monitor performance of the advertisements that are distributed using the campaign parameters. For example, an advertiser can access a campaign performance report that provides a number of impressions (i.e., presentations), selections (i.e., clicks), and conversions that have been identified for the advertisements.

The campaign performance report can also provide a total cost, a cost-per-click, and other cost measures for the advertisement over a specified period. For example, an advertiser may access a performance report that specifies that advertisements distributed using the phrase match keyword “hockey” have received 1,000 impressions (i.e., have been presented 1,000 times), have been selected (e.g., clicked) 20 times, and have been credited with 5 conversions. Thus, the phrase match keyword “hockey” can be attributed with 1,000 impressions, 20 clicks, and 5 conversions.

One example of online advertisement offers pay-per-click (PPC) advertising, cost-per-thousand (CPM) advertising, and site-specific advertising for text, banner, and rich-media advertisements. The program includes local, national, and international distribution. The text advertisements can be short, generally comprising one headline of 25 characters and two additional text lines of 35 characters each. Image advertisements can be one of several different Interactive Advertising Bureau (IAB) standard sizes.

In some implementations in which the advertisement campaign comprises a PPC advertisement, advertisers select the words that should trigger their advertisements and the maximum amount they will pay per click. When a user searches on a search engine, advertisements for relevant words appear as “sponsored links” on the (right or left) side of the page, and sometimes above or below the main search results. In some implementations, advertisements can appear on any portion of a page. The ordering of the paid-for listings can depend on other advertisers' bids (PPC) and factors such as the “quality score” of all advertisements shown for a given search. In some implementations, the advertisement management system 110 determines the factors based on historical click-through rates, predicted click-through rates, relevance of an advertiser's advertisement text and keywords, an advertiser's account history, and other relevance factors. The quality score can be also used to set the minimum bids for an advertiser's keywords. The minimum bid takes into consideration the quality of the landing page as well, which includes the relevancy and originality of content, navigability, and transparency into the nature of the business.

In some implementations, a “user” may refer to any company, organization, partnership, individual, agent, or entity that is involved in online advertising. Thus, in some implementations “user” and “advertiser” can be used interchangeable. Keyword coverage refers to the number of searches done by “search engine users” that result in a paid result—an advertisement—being displayed. For example, 50% of searches conducted on a search engine may result in a paid advertisement being displayed. Out of that, 1% of the searches may result in a specific advertiser's URL being advertised. In general, the online advertiser's goal may be to have its advertisement appear on a display page after as many relevant searches as possible. One way an advertiser can extend their keyword coverage may be by purchasing additional keywords, thus increasing the likelihood that their advertisement will appear on displays of search results. The number of paid results per keyword can vary, and where a URL ranks among the paid results can depend on several factors, including relevancy and the keyword purchase price.

There are several ways an advertiser selects keywords to purchase. For example, an advertiser can select a group of keywords that define the products, services, or content it offers on its web page. An advertiser may try to expand its keyword selection by selecting all synonyms, or by selecting keywords that are related, in some manner, to the products, services or content it offers on its web page. An advertiser may try to optimize its selection of keywords by monitoring how effective each keyword is. For example, the advertiser may use a tool that records the number of times a purchased keyword is entered into a search engine and the number of times that results in their web page being viewed.

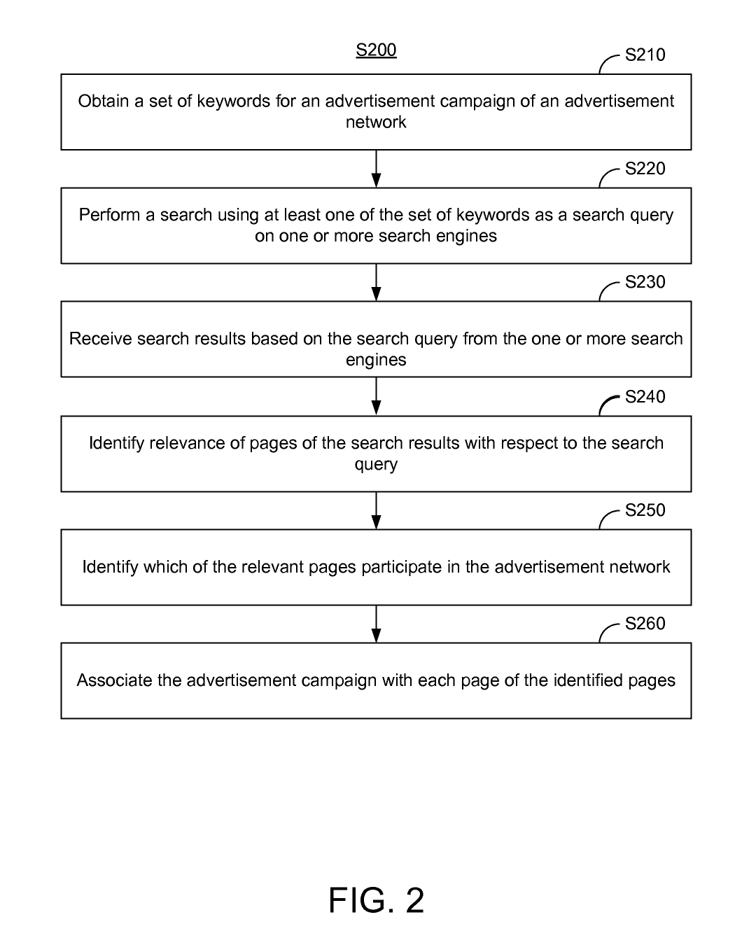

Various methods may be implemented using the system from FIG. 1. For example, FIG. 2 is a method S200 that may be used to manage advertisements in an advertisement network. According to various implementations, an advertisement network refers to a collection of advertisements generally to be provided on the Internet or the like.

With reference to FIGS. 1 and 2, at block S210, a set of keywords for an advertisement campaign of the advertisement network may be obtained. An advertiser may already have an advertisement program account or may create a new account at this point. The advertiser may already have some keywords in its advertisement campaign, or the advertiser may not even have an advertisement campaign at this block. At this block, the advertiser may choose to provide its own keywords, or the advertiser may choose to have its keywords automatically generated for the advertiser or suggested to the advertiser, for instance, by the advertisement management system 110. For instance, the advertisement management system 110 may provide the advertiser with a list of keywords associated with the advertisement campaign of the advertiser.

In various implementations, the keywords may be used to determine which pages will be displayed when search queries corresponding to the keywords are input in a search engine. For instance, at block S220 a search query (or additional search queries) may be selected for inputting to a search engine. The search query may correspond to a keyword selected from the set of keywords for the advertisement campaign. For example, the selected keyword may be the keyword in the advertisement campaign with the highest ROI conversion, click-through rate (CTR), or otherwise meets some specified criteria or threshold. In some implementations, the search query may be selected by the advertiser. For instance, in some implementations, the advertiser may select one (or more) of the keywords from the set of keywords for use as the search query. In other implementations, the search query may be selected by the advertisement management system 110. For instance, the advertisement management system 110 may select one (or more) of the keywords (e.g., keyword with highest conversion or click-through rate) from the set of keywords for use as the search query.

At block S230, search results based on the search query are determined for one or more search engines (e.g., Google). For instance, the search results may be determined by inputting the search query into the one or more search engines to perform a search. Accordingly, search results may be received based on the search query. The search results can include, for example, one or more pages (websites) or links thereto or other metadata about pages. One or more servers corresponding to the search engine can identify, from a search index, content that corresponds to the received search terms.

At block S240, relevance of each of the pages may be determined with respect to the search query. For instance, in some implementations, the top N (e.g., 100) pages may be identified. Accordingly, these N pages may be deemed relevant, whereas other pages may be deemed not relevant (or not as relevant). In particular implementations, the value of N may be based on some specified criteria, such as Google Page Rank, Google +1, and/or the like.

In some cases, one or more of the search result pages may be associated with the advertisement network, and to which the advertisement management system 110 can provide content for presentation. At block S250, the advertisement management system 110 determines which pages of the relevant pages participate in the advertisement network. For instance, the advertisement management system 110 may compare the relevant pages to a catalog of pages participating in the advertisement network. At block S260, the advertisement management system 110 associates the advertisement campaign with each identified page such that advertisements from the advertisement campaign may be provided (e.g., displayed) on one or more of these pages.

As a result, an advertisement associated with the advertisement campaign can be provided to the user device. In particular, the advertisement can be provided both with search results that include links to one or more of the identified pages, as well as with one or more of the identified pages when the pages are accessed by the user device (e.g., in response to receiving a selection of a search results link). As such, various implementations identify high-performing segments of advertisement networks so advertisers can obtain a higher return on investment so end users can be provided with the most relevant content.

As described in FIG. 2, the advertisement management system 110 may match (associate) advertisement campaigns with relevant pages in advance of requesting an advertisement from the advertisement campaign. The requesting may occur, for instance, when an end user performs a search using a search query that provides results along with the advertisement. In addition (or in the alternative), the requesting may occur, for instance, when the end user accesses one or more of the relevant pages, for example as selected from the search results, on which the advertisement is to be provided. Furthermore, by associating the advertisement campaigns to the relevant pages, advertisements from the advertisement campaigns may be provided on one of the relevant pages if accessed inorganically (i.e., not accessed from a link in search results) or if accessed from a link in search results obtained on a search engine (e.g., the second search engine) that was different from the search engine used above.

The advertisement management system 110 may serve content from advertisement campaigns with relevant pages based on previously defined associations of advertisement campaigns and pages. Accordingly, advertisements from the advertisement campaign may be provided along with the search results for the search and with certain pages selected from the search results.

For instance, with reference to FIGS. 1-4, at block S410, a search query on a search engine may be received as input. For example, an end user (e.g., via an end user device, such as a mobile device, computer, or the like) may input the search query into the search engine to perform a search. Accordingly, at block S420, search results, which contain several pages (websites) or links thereto or other metadata about the pages, may be identified to be provided to the end user based on the search query.

In some cases, one or more of the search result pages may be associated with the advertisement network. At block S430, the advertisement management system 110 may identify advertisement campaigns associated with the search results. For example, the system 110 may identify advertisement campaigns previously associated with web pages based on search engine results for queries corresponding to keywords of the advertisement campaigns.

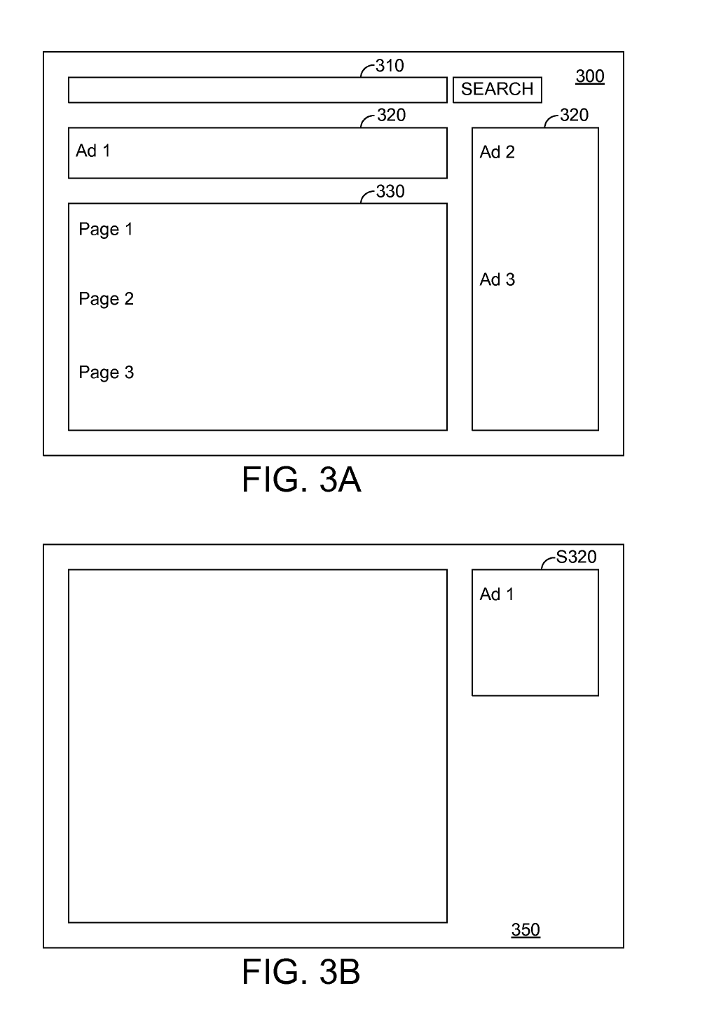

At block S440, a first advertisement associated with the identified advertisement campaign (e.g., identified at block S430) may be provided to the end user (end user device) along with the search results that include links to one or more of the identified pages (e.g., as shown in FIG. 3A). At block S450, a selection of a page that is a search result may be received. Accordingly at block S460, an advertisement, which may be same or different as the previously served advertisement, associated with the advertisement campaign may be served on the selected page (e.g., as shown in FIG. 3B).

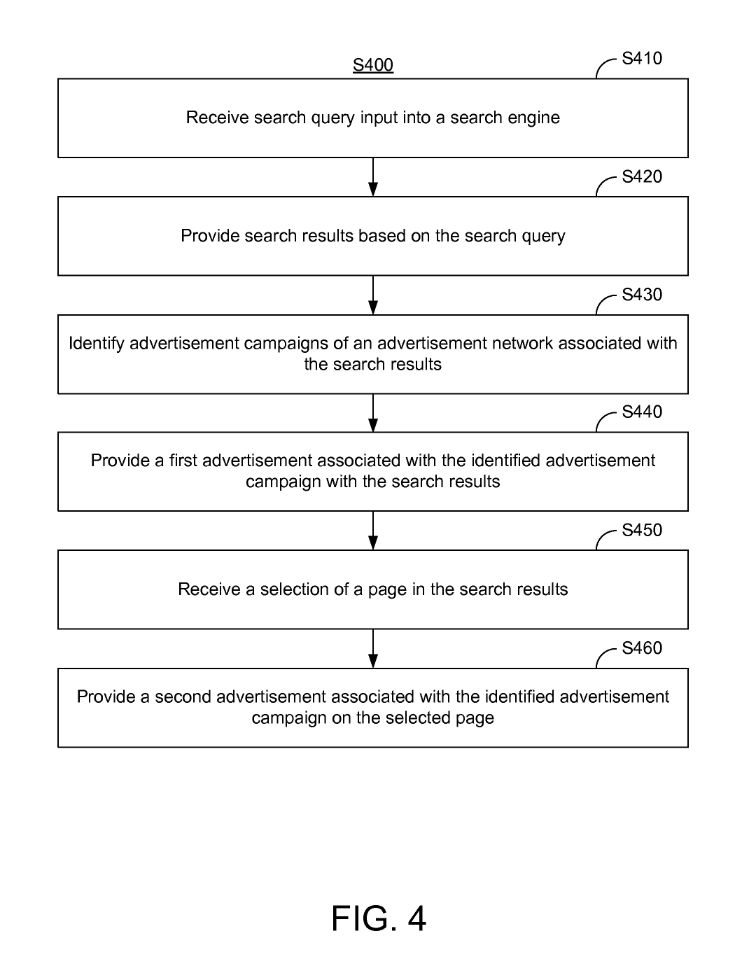

Different interfaces can be used to provide content to a user device across a search results page and a page accessed from the search results page. FIG. 3A illustrates a screen 300 that may be presented to an end user (e.g., user of a search engine), which for instance may occur at block S420 of FIG. 4. With reference to FIGS. 3A and 4, as shown, a search query entered into a search field 310 by the end user may cause search results 330 (e.g., “Page 1,” “Page 2,” and “Page 3”) to be displayed along with paid search advertisements 320 (e.g., “Ad 1,” “Ad 2,” and “Ad 3”). If Page 1 participates in the advertisement network, when the end user selects (e.g., clicking on, tapping, etc.) a link to Page 1, Page 1 may be displayed along with Ad 1, as shown in illustrative screen 350 of FIG. 3B. Thus, if the end user does not select Ad 1 when displayed with the search results 330 and the other paid search advertisements 320, the advertiser may receive a second opportunity for the end user to select Ad 1 when the end user visits one of the identified websites provided in the search results.

With reference to FIGS. 2-4, in some implementations, Ad 1 may be displayed on Page 1 if an end user visits Page 1 directly without selecting the page from search results (organically). This is because the page is already associated with the advertisement campaign (e.g., block S260 in FIG. 2). In some implementations, Ad 1 may be displayed on Page 1 if an end user selects the page from search results on a first search engine (e.g., a first search engine) that corresponds to one of the one or more search engines for which search results were determined (e.g., block S230). Likewise, Ad 1 may be displayed on Page 1 if the end user (or different end user) selects the page from search results on a second search engine (which may be different from the first search engine) of the one or more search engines.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the implementations disclosed herein may be implemented as electronic hardware, computer software embodied on a tangible medium, or combinations of both. To clearly illustrate this interchangeability of hardware and software, various illustrative components, blocks, modules, circuits, and steps have been described above generally in terms of their functionality. Whether such functionality may be implemented as hardware or software embodied on a tangible medium depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An illustrative storage medium may be coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more illustrative implementations, the functions described may be implemented in hardware, software or firmware embodied on a tangible medium, or any combination thereof. If implemented in software, the functions may be stored on or transmitted over as one or more instructions or code on a computer-readable medium. Computer-readable storage media includes both computer storage media and communication media including any medium that facilitates transfer of a computer program from one place to another. A storage media may be any available media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-Ray disc where disks usually reproduce data magnetically, while discs reproduce data optically with lasers. Combinations of the above should also be included within the scope of computer-readable storage media. The computer-readable storage medium does not include a transitory signal.

In various implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-Ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content that may be then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

What is claimed is:

1. A method of managing advertisements, comprising:
obtaining, by a server, a set of keywords for an advertisement campaign of an advertisement network;
performing a search using at least one of the set of keywords as a search query on one or more search engines;
receiving search results based on the search query from the one or more search engines, the search results comprising a plurality of pages;
identifying a set of pages that participate in the advertisement network from the plurality of pages; and
associating the advertisement campaign with each page of the identified set of pages.

2. The method of claim 1, further comprising:
providing one or more advertisements associated with the advertisement campaign to a page of the identified set of pages

3. The method of claim 1, further comprising:
receiving, from a user device, a user search query input into a search engine, the user search query corresponding to at least one of the set of keywords;
providing search results based on the user search query, the search results comprising a plurality of pages; and
providing a first advertisement from the advertisement campaign for display with the search results.

4. The method of claim 3, further comprising:
receiving a selection of a page from the search results; and
providing a second advertisement associated with the advertisement campaign for display on the selected page.

5. The method of claim 4, wherein the first advertisement and the second advertisement are associated with the same advertiser.

6. The method of claim 4, wherein the first advertisement and the second advertisement are the same advertisement.

7. The method of claim 1, the further comprising:
determining relevance of each page of the plurality of pages to the first search query;
wherein the identifying the set of pages comprises:
identifying a set of pages of the plurality of pages that participate in the advertisement network and have a relevance exceeding a predetermined threshold.

8. The method of claim 7, wherein the relevance of each page of the plurality of pages is based on a position of the page in the search results.

9. The method of claim 1, wherein the search query is selected based on a keyword in the set of keywords that meets a specified criterion.

10. The method of claim 1,
wherein the identifying the set of pages comprises:
comparing the plurality of pages to a catalog of pages participating in the advertisement network; and
identifying the set of pages that correspond to pages of the catalog.

11. A method of managing advertisements, the method comprising:
receiving, by a server, search query input into a search engine;
providing search results based on the search query, the search results comprising a plurality of pages;
identifying a set of pages of the plurality of pages that participate in an advertisement network;
providing a first advertisement associated with the advertisement campaign for display with the search results;
receiving a selection from the search results of a page from the set of pages; and
providing a second advertisement associated with the advertisement campaign on the selected page.

12. The method of claim 11, wherein the first advertisement and the second advertisement are associated with the same advertiser.

13. The method of claim 11, wherein the first advertisement and the second advertisement are the same advertisement.

14. A computer program product for managing advertisements, the computer program product comprising:
a computer-readable storage medium comprising code for:
obtaining, by a server, a set of keywords for an advertisement campaign of an advertisement network;
performing a search using at least one of the set of keywords as a search query on one or more search engines;
receiving search results based on the search query from the one or more search engines, the search results comprising a plurality of pages;
identifying a set of pages that participate in the advertisement network from the plurality of pages; and
associating the advertisement campaign with each page of the identified set of pages.

15. The computer program product of claim 14, the computer-readable storage medium further comprising code for:
receiving, from a user device, a user search query input into a search engine, the user search query corresponding to at least one of the set of keywords;
providing search results based on the user search query, the search results comprising a plurality of pages; and
providing a first advertisement from the advertisement campaign for display with the search results.

16. The computer program product of claim 15, the computer-readable storage medium further comprising code for:
receiving a selection of a page from the search results; and
providing a second advertisement associated with the advertisement campaign for display on the selected page.

17. The computer program product of claim 16, wherein the first advertisement and the second advertisement are associated with the same advertiser.

18. The computer program product of claim 16, wherein the first advertisement and the second advertisement are the same advertisement.

19. A system for managing advertisements, comprising:
an advertisement management server configured to:
obtain a set of keywords for an advertisement campaign of an advertisement network, the server configured;
perform a search using at least one of the set of keywords as a search query on one or more search engines;
receive search results based on the search query from the one or more search engines, the search results comprising a plurality of pages;
identify a set of pages that participate in the advertisement network from the plurality of pages; and
associate the advertisement campaign with each page of the identified set of pages.
